(19) United States
(12) Patent Application Publication
(10) Pub. No.: US 2016/0257072 A1
(43) Pub. Date: Sep. 8, 2016

(54) THREE-DIMENSIONALLY SHAPED ARTICLE PRODUCTION APPARATUS AND THREE-DIMENSIONALLY SHAPED ARTICLE

(71) Applicant: SEIKO EPSON CORPORATION, Tokyo (JP)

(72) Inventors: Eiji OKAMOTO, Matsumoto-shi (JP); Toshimitsu HIRAI, Hokuto-shi (JP)

(21) Appl. No.: 15/057,484

(22) Filed: Mar. 1, 2016

(30) Foreign Application Priority Data
Mar. 4, 2015 (JP) 2015-042105

(51) Int. Cl. B29C 67/00

(52) U.S. Cl. CPC B29C 67/0081; B29C 67/0085; B33Y 30/00

(57) ABSTRACT

A three-dimensionally shaped article production apparatus is an apparatus for producing a three-dimensionally shaped article by stacking a layer, and includes: a shaping section in which the three-dimensionally shaped article is formed; a layer forming unit which forms the layer using a three-dimensional shaping composition containing particles; and an ejection unit which ejects a binding liquid containing a binding agent for binding the particles onto the layer. The shaping section includes a mask which has an opening with a size corresponding to the size of the three-dimensionally shaped article, and the layer is formed in the opening.

### BACKGROUND

1. Technical Field

The present invention relates to a three-dimensionally shaped article production apparatus and a three-dimensionally shaped article.

2. Related Art

There has been known a technique for shaping a three-dimensional object while consolidating a powder with a binding liquid (see, for example, JP-A-6-218712 (PTL 1)). In this technique, by repeating a procedure as follows, a three-dimensional object is shaped. First, a powder (three-dimensional shaping composition) is thinly spread to a uniform thickness to form a powder layer, and a binding liquid is ejected onto a desired portion of this powder layer, whereby powder particles are bound to one another. As a result, in the powder layer, only the portion onto which the binding liquid is ejected is bound, whereby a member in the form of a thin plate (hereinafter referred to as “cross-sectional member”) is formed. Thereafter, a powder layer is further formed thinly on the powder layer, and a binding liquid (curable ink) is ejected onto a desired portion. As a result, a new cross-sectional member is formed also in the portion onto which the binding liquid is ejected of the newly formed powder layer. At this time, the binding liquid ejected onto the powder layer soaks into the powder layer to reach the previously formed cross-sectional member, and therefore, the newly formed cross-sectional member is also bound to the previously formed cross-sectional member. By repeating such a procedure, thin plate-shaped cross-sectional members are stacked one by one, whereby a three-dimensional object can be shaped.

In such a three-dimensional shaping technique, shaping can be immediately performed by binding a powder as long as the three-dimensional shape data of an object to be shaped is available, and it is not necessary to form a mold or the like prior to shaping, and therefore, it is possible to shape a three-dimensional object rapidly and also inexpensively. Further, since shaping is performed by stacking thin plate-shaped cross-sectional members one by one, even a complicated object having, for example, an internal structure can be formed as an integrated shaped article without being divided into a plurality of components.

However, in a three-dimensionally shaped article production apparatus in the related art, shaping is performed in a shaping region with a fixed area regardless of the size of a three-dimensionally shaped article to be produced, and therefore, a three-dimensional shaping composition is used more than necessary depending on the size of the three-dimensionally shaped article. As a result, a problem arises that the production efficiency decreases.

### SUMMARY

An advantage of some aspects of the invention is to provide a three-dimensionally shaped article production apparatus capable of increasing the efficiency of producing a three-dimensionally shaped article, and also to provide a three-dimensionally shaped article with high reliability.

A three-dimensionally shaped article production apparatus according to an aspect of the invention is an apparatus for producing a three-dimensionally shaped article by stacking a layer, and includes: a shaping section in which the three-dimensionally shaped article is formed; a layer forming unit which forms the layer using a three-dimensional shaping composition containing particles; and an ejection unit which ejects a binding liquid for binding the particles onto the layer, wherein the shaping section includes a mask which has an opening with a size corresponding to the size of the three-dimensionally shaped article, and the layer is formed in the opening.

According to this configuration, the efficiency of producing a three-dimensionally shaped article can be increased.

In the three-dimensionally shaped article production apparatus according to the aspect of the invention, it is preferred that the mask is detachable.

According to this configuration, the efficiency of producing a three-dimensionally shaped article can be further improved.

In the three-dimensionally shaped article production apparatus according to the aspect of the invention, it is preferred that the three-dimensional shaping composition contains a solvent.

According to this configuration, a three-dimensionally shaped article can be more efficiently produced.

In the three-dimensionally shaped article production apparatus according to the aspect of the invention, it is preferred that the shaping section includes a support to which the mask is fixed, and a lift stand which goes up and down with respect to the support.

According to this configuration, a three-dimensionally shaped article can be more efficiently produced.

In the three-dimensionally shaped article production apparatus according to the aspect of the invention, it is preferred that the apparatus includes a shaping stage, which is placed on the upper surface of the lift stand, and on which the layer is stacked, and the shaping stage has a size corresponding to the size of the opening.

According to this configuration, the efficiency of producing a three-dimensionally shaped article can be further improved.

In the three-dimensionally shaped article production apparatus according to the aspect of the invention, it is preferred that the shaping stage is constituted by a porous body.

According to this configuration, in the case where a solvent is contained in the three-dimensional shaping composition, the solvent can be more efficiently removed.

A three-dimensionally shaped article according to an aspect of the invention is produced by the three-dimensionally shaped article production apparatus according to the aspect of the invention.

According to this configuration, a three-dimensionally shaped article with high reliability can be provided.

### BRIEF DESCRIPTION OF THE DRAWINGS

The invention will be described with reference to the accompanying drawings, wherein like numbers reference like elements.

FIG. 1 is a cross-sectional view from the side of a side surface of a preferred embodiment of a three-dimensionally shaped article production apparatus according to the invention.

FIG. 2 is a plan view when viewed in plan view from the top of the three-dimensionally shaped article production apparatus shown in FIG. 1.

FIG. 3 is an enlarged cross-sectional view showing another example of a shaping section of the three-dimensionally shaped article production apparatus.

### DESCRIPTION OF EXEMPLARY EMBODIMENTS

Hereinafter, preferred embodiments of the invention will be described in detail with reference to the accompanying drawings.

### 1. Three-Dimensionally Shaped Article Production Apparatus

First, preferred embodiments of a three-dimensionally shaped article production apparatus according to the invention will be described.

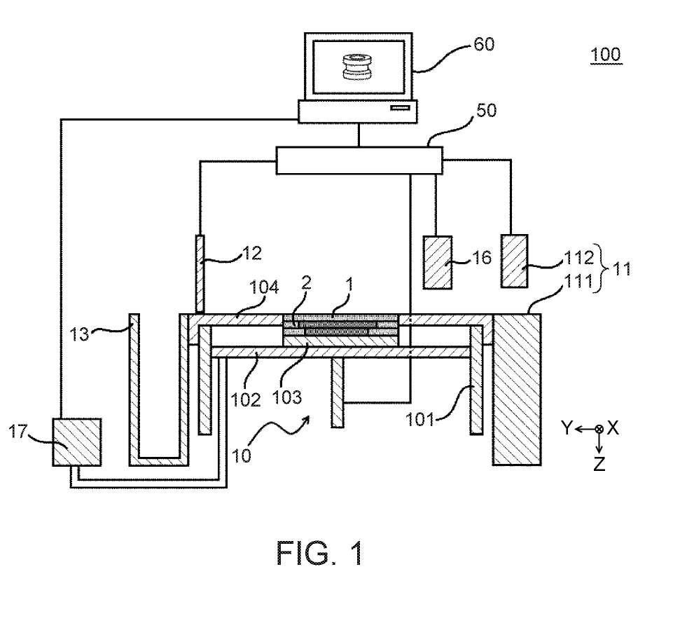

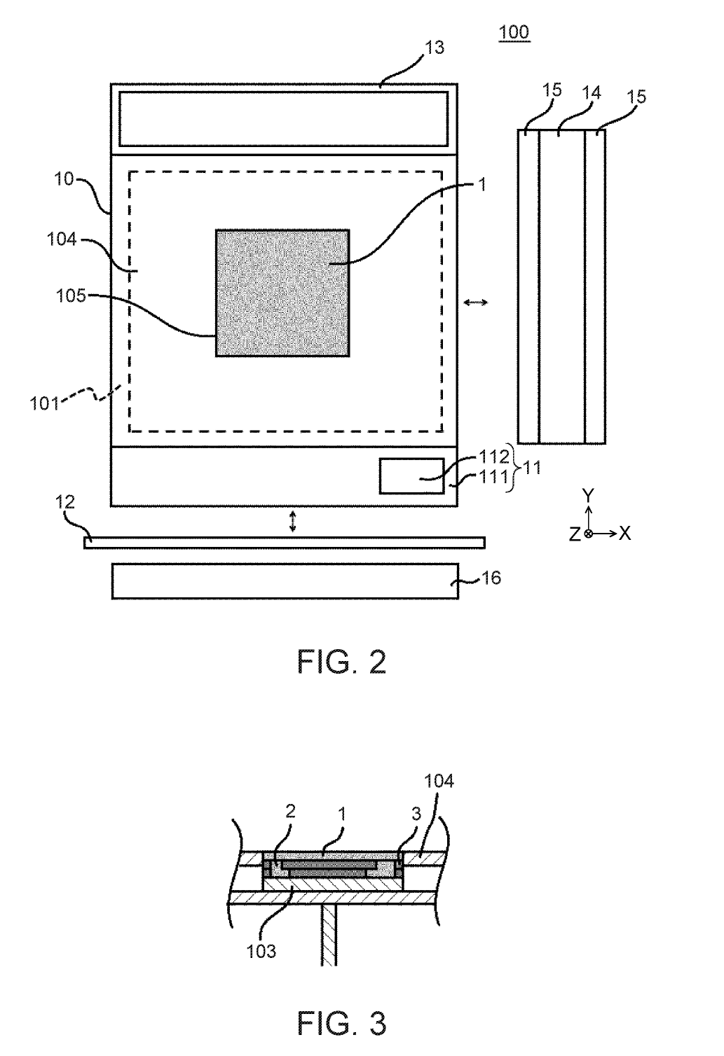

FIG. 1 is a cross-sectional view from the side of a side surface of a preferred embodiment of a three-dimensionally shaped article production apparatus according to the invention. FIG. 2 is a plan view when viewed in plan view from the top of the three-dimensionally shaped article production apparatus shown in FIG. 1. FIG. 3 is an enlarged cross-sectional view showing another example of a shaping section of the three-dimensionally shaped article production apparatus.

A three-dimensionally shaped article production apparatus 100 is an apparatus for producing a three-dimensionally shaped article by stacking a layer 1 formed using a three-dimensional shaping composition containing particles.

As shown in FIGS. 1 and 2, the three-dimensionally shaped article production apparatus 100 includes a shaping section 10 in which a three-dimensionally shaped article is shaped, a supply section 11 which supplies a three-dimensional shaping composition, a squeegee (layer forming unit) 12 which forms a layer 1 of the three-dimensional shaping composition in the shaping section 10 using the supplied three-dimensional shaping composition, a recovery section 13 which recovers the excess three-dimensional shaping composition when the layer 1 is formed, a heating section 16 which heats the layer 1, an ejection section 14 which ejects a binding liquid containing a binding agent onto the layer 1, and a UV irradiation unit 15 which irradiates the layer 1 with a UV light. The three-dimensional shaping composition and the binding liquid will be described in detail later.

As shown in FIGS. 1 and 2, the shaping section 10 includes a frame body 101, and a lift stage (lift stand) 102, a shaping stage 130, and a mask 104, each provided inside the frame body 101.

The frame body 101 is constituted by a frame-shaped member.

The lift stage 102 has a rectangular shape in the XY plane.

The lift stage 102 is configured to be driven (go up and down) in the Z-axis direction by a driving unit (not shown).

The shaping stage 103 is provided on the lift stage 102 and has a rectangular shape in the XY plane.

The shaping stage 103 is configured such that the area in plan view thereof is smaller than the area in plan view of the lift stage 102.

The layer 1 is formed on this shaping stage 103.

The shaping stage 103 is replaceable with another one with a different size according to the size of the three-dimensionally shaped article to be formed.

The shaping stage 103 can be constituted by, for example, a porous body. According to this, for example, in the case where a solvent is contained in the three-dimensional shaping composition, the solvent can be easily removed from the layer 1.

In the case where a composition containing particles and a solvent was used as a layer forming composition, it was difficult to sufficiently remove the solvent from the layer, and there were limits to the reduction in the amount of heat for evaporation when the solvent was dried, the suppression of foaming caused by rapid evaporation of the solvent, and the suppression of vapor diffusion in the apparatus. However, by constituting the shaping stage by a porous body as described above, the solvent can be efficiently removed from the layer 1.

In the lift stage (lift stand) 102, a plurality of pores are provided. To the lift stage (lift stand) 102, a sucking mechanism 17 for sucking the solvent in the layer 1 through the pores and the shaping stage 103 is connected. As the sucking mechanism, for example, any of various pumps can be used.

When the shaping stage 103 has a portion constituted by a sintered body of particles constituted by a metal material or a ceramic material, the strength, heat resistance, durability, weight reduction, and the like can be made particularly excellent.

The mask 104 is fixed to the frame body (support) 101. Further, the mask 104 is provided to cover the frame body 101.

In the mask 104, an opening 105 is provided at a position corresponding to that of the shaping stage 103. The opening 105 and the shaping stage 103 are configured to have the same shape in plan view.

The layer 1 is formed in a region formed by the inner wall surface of this opening 105 and the shaping stage 103.

This mask 104 is attached to the frame body 101 in a detachable manner in the shaping section 10. Further, according to the size of the three-dimensionally shaped article to be produced, multiple types of masks having an opening of a different size may be detachable in the shaping section 10.

Such a shaping section 10 can be driven in the X-axis direction by a driving unit (not shown). By supporting the shaped article including the side surface of the uppermost layer of the layer 1 by the mask 104, even if the height of the shaped article is increased, the shaped article does not become unstable, and unexpected collapse of the shaped article can be prevented.

Further, the mask 104 is configured to cover the entire shaping surface of the lift stage 102 excluding the shaping region. The mask 104 may be constituted by one member with the opening 105 formed therein, or may be constituted by a plurality of members to form the opening 105.

The opening 105 may not be located in the center of the lift stage 102. For example, the opening 105 may be located at an end of the lift stage 102 closest to the ejection section 14.

Then, when the shaping section 10 moves in the X-axis direction, that is, moves to a drawing area where the below-mentioned ejection section 14 performs drawing, the binding liquid is ejected onto the layer 1 by the ejection section 14.

The supply section 11 has a function to supply the three-dimensional shaping composition into the three-dimensionally shaped article production apparatus 100.

The supply section 11 includes a supply region 111 where the three-dimensional shaping composition is supplied and a supply unit 112 which supplies the three-dimensional shaping composition to the supply region 111.

The supply region 111 has a rectangular shape which is long in the X-axis direction and is provided in contact with one side of the frame body 101. Further, the supply region 111 is provided flush with the upper surface of the mask 104.

The three-dimensional shaping composition supplied to the supply region 111 is conveyed to the shaping stage 103 by the below-mentioned squeegee 12 to form the layer 1.

The squeegee (layer forming unit) 12 has a plate shape which is long in the X-axis direction. Further, the squeegee 12 is configured to be driven in the Y-axis direction by a driving unit (not shown). Further, the squeegee 12 is configured such that the tip in the short axis direction thereof comes in contact with the upper surface of the mask 104 and the supply region 111.

The squeegee 12 conveys the three-dimensional shaping composition supplied to the supply region 111 to the shaping stage 103 while moving in the Y-axis direction to form the layer 1 on the shaping stage 103.

In this embodiment, a configuration in which the moving direction of the squeegee 12 and the moving direction of the shaping section 10 intersect (are orthogonal to) each other is adopted. By adopting such a configuration, while ejecting the binding liquid by the ejection section 14, preparations for the formation of the subsequent layer 1 can be made, and thus, the efficiency of producing the three-dimensionally shaped article can be improved.

The recovery section 13 is a box-shaped member having an opened upper surface and is provided as a separate body from the shaping section 10. The recovery section 13 has a function to recover the excess three-dimensional shaping composition in the formation of the layer 1.

The recovery section 13 is in contact with the mask 104, and is provided to face the supply section 11 through the mask 104.

The excess three-dimensional shaping composition conveyed by the squeegee 12 is recovered by the recovery section 13 and the recovered three-dimensional shaping composition is reused.

The heating section 16 has a function to remove and dry the solvent or the like contained in the layer 1 by heating the formed layer 1. The heating section 16 is configured to be driven in the Y-axis direction by a driving unit (not shown).

The ejection section 14 has a function to eject the binding liquid onto the formed layer 1.

Specifically, when the shaping section 10 in which the layer 1 is formed on the shaping stage 103 moves in the X-axis direction, and reaches the drawing area in the lower part of the ejection section 14, the binding liquid is ejected from the ejection section 14 onto the layer 1.

The ejection section 14 is mounted with a liquid droplet ejection head which ejects a liquid droplet of the binding liquid by an inkjet method. Further, the ejection section 14 includes a binding liquid supply section (not shown). In this embodiment, a liquid droplet ejection head using a so-called piezoelectric drive system is adopted.

Two UV irradiation units 15 are provided at both ends in the moving direction (X-axis direction) of the ejection section 14.

The UV irradiation unit 15 has a function to cure the binding agent in the layer 1 and bind the particles in the layer 1 by irradiating the layer 1 with a UV light.

According to the three-dimensionally shaped article production apparatus 100 as described above, by the mask 104, the shaping region can be reduced, and therefore, the amount of the three-dimensional shaping composition to be used for production can be reduced. As a result, the production efficiency can be further increased.

Further, by replacement with the mask 104 having an opening of a different size, the three-dimensionally shaped article of a different size can be efficiently produced.

Further, by using the shaping stage 103 having a size and a thickness corresponding to the opening 105 of the mask 104 in combination, the shaping stage 103 can be made to go up and down to a height corresponding to the thickness of the opening 105 of the mask 104 without being limited to the thickness of the mask 104, and thus, the three-dimensionally shaped article can be efficiently produced.

Further, in the case where a composition containing a solvent is used as the three-dimensional shaping composition, the layer 1 can be temporarily fixed by drying, whereby collapse of the layer 1 in an edge portion of the layer 1 can be prevented. As a result, the shaped article can be disposed in the vicinity of the outer edge of the shaping stage, and therefore, the three-dimensionally shaped article can be more efficiently produced.

In the case where a composition composed only of a powder is used as the three-dimensional shaping composition, as shown in FIG. 3, the binding liquid is applied to a region where the mask 104 and the layer 1 come in contact with each other to bind the particles in the region and form a collapse prevention region 3, whereby collapse of the layer 1 at an edge portion of the layer 1 can be prevented.

Further, as shown in FIG. 1, the three-dimensionally shaped article production apparatus 100 includes a control section 50 and a computer 60 connected to the control section 50.

The control section 50 includes a CPU and a memory. The CPU controls the above-mentioned respective sections by loading a computer program stored in the memory or a recording medium into the memory and executing the program.

In the three-dimensionally shaped article production apparatus 100, the computer 60 selects the mask 104 by the recommendation for the shaping time, shaping accuracy, minimal material, etc. based on the shaping data (planar arrangement, stacking arrangement, etc.) including three-dimensional data representing the shape of the three-dimensionally shaped article. Depending on the number of shaped articles or the size thereof, a worker may select the mask 104 and input the information of the selected mask 104 to the computer 60.

The control section 50 controls the control section 11 and the squeegee (layer forming unit) 12 and selects the supply amount of the material, the supply width of the material, and the supply position of the material on a timely basis, and the three-dimensional shaping composition is applied and spread.

Incidentally, in the above description, a case where the squeegee 12 is used as the layer forming unit has been described, however, the unit is not limited to the squeegee, and may be, for example, a roller.

Further, the place where the mask 104 is attached may be a place other than in the frame body 101 as long as it is a place which does not move vertically along with the lift stage 102.

Further, in the recovery section 13, a removal unit which removes the three-dimensional shaping composition adhered to the squeegee 12 may be provided. As the removal unit, an ultrasound, wiping off, static electricity, or the like can be used.

Further, in the case where the three-dimensional shaping composition contains a solvent, the three-dimensionally shaped article production apparatus 100 may include a heating unit.

Further, in the above description, a case where the apparatus includes the UV irradiation unit 15 has been described, however, the apparatus is not limited thereto. For example, in the case where the binding agent contains a thermosetting resin, the apparatus may include a heating unit in place of the UV irradiation unit.

Further, in the above description, a configuration in which the shaping stage 103 goes up and down by the lift stage 102 has been described, however, the configuration is not limited thereto, and, for example, a configuration in which the lift stage 102 is fixed and the mask 104 goes up and down may be adopted.

### 2. Three-Dimensionally Shaped Article Production Method

A three-dimensionally shaped article production method according to the invention is a method for producing a three-dimensionally shaped article by stacking a layer formed using a three-dimensional shaping composition containing particles.

The three-dimensionally shaped article production method of this embodiment includes a layer forming step of forming a layer 1 using a three-dimensional shaping composition containing particles, an ejection step of ejecting a binding liquid onto the layer 1, and a UV irradiation step of irradiating the layer 1 with a UV light.

Hereinafter, a case where the above-mentioned three-dimensionally shaped article production apparatus 100 is used will be described as a specific example.

First, by the supply unit 112, a three-dimensional shaping composition is supplied to the supply region 111.

Subsequently, the three-dimensional shaping composition supplied to the supply region 111 is conveyed to the shaping stage 103 while moving the composition on the mask 104 by the squeegee 12 to form the layer 1 (layer forming step). Incidentally, the layer 1 may be formed by supplying the three-dimensional shaping composition onto the mask 104 close to the shaping stage 103.

The thickness of the layer 1 is not particularly limited, but is preferably 5 μm or more and 500 μm or less, more preferably 10 μm or more and 100 μm or less. According to this, while making the productivity of the three-dimensionally shaped article sufficiently excellent, the occurrence of undesirable irregularities or the like in the three-dimensionally shaped article to be produced is more effectively prevented, and the dimensional accuracy of the three-dimensionally shaped article can be made particularly excellent.

After the layer 1 is formed, the excess three-dimensional shaping composition is moved on the mask 104 and recovered by the recovery section 13.

Subsequently, according to need, the solvent or the like contained in the layer 1 is removed by heating the layer 1.

Subsequently, the shaping section 10 in which the layer 1 is formed is moved in the X-axis direction, and the binding liquid is ejected onto the layer 1 in the drawing area where the ejection section 14 performs drawing (ejection step).

Subsequently, the layer 1 is irradiated with a UV light by the UV irradiation unit 15 to cure the binding agent in the layer 1, whereby the cured layer 1 and an uncured portion 2 are formed (UV irradiation step).

Thereafter, the shaping stage 103 is descended in the Z-axis direction by the thickness of the layer 1 to be formed, and the above-mentioned respective steps are repeated sequentially. By doing this, the three-dimensionally shaped article is formed.

The three-dimensionally shaped article produced as described above has high reliability.

A layer (sacrifice layer) may be formed directly on the lift stand without using the shaping stage 103. First, the upper surface (a surface on which the layer is formed) of the lift stage 102 and the lower surface (a surface on which the three-dimensional shaping composition is not conveyed) of the mask 104 are brought into contact with each other. Subsequently, by the supply unit 112, the three-dimensional shaping composition is supplied to the supply region 111. Then, the three-dimensional shaping composition supplied to the supply region 111 is conveyed to the opening of the mask 104 while moving the composition on the mask 104 by the squeegee to form the layer 1 (sacrifice layer forming step). Incidentally, the layer 1 may be formed by supplying the three-dimensional shaping composition onto the mask 104 close to the shaping stage 103. The sacrifice layer is formed to have the same thickness as that of the mask 104. After the sacrifice layer is formed, the excess three-dimensional shaping composition is moved on the mask 104 and recovered by the recovery section 13.

Subsequently, according to need, the solvent or the like contained in the layer 1 is removed by heating the sacrifice layer. Thereafter, the shaping stage 103 is descended in the Z-axis direction by the thickness of the layer to be formed, and the respective steps after the above-mentioned layer forming step are repeated sequentially. By doing this, the three-dimensionally shaped article is formed.

Incidentally, the thickness of the mask 104 is larger than the amount of movement of the lift stage 102 (the thickness of the layer 1). According to this, by supporting the shaped article including the side surface of the uppermost layer of the layer 1 by the mask 104, even if the height of the shaped article is increased, the shaped article does not become unstable, and unexpected collapse of the shaped article can be prevented. Further, the movement of the shaping section, that is, the movement of the shaped article in the shaping process can be stably performed.

### 3. Three-Dimensional Shaping Composition

Next, the three-dimensional shaping composition will be described in detail.

The three-dimensional shaping composition contains a plurality of particles and a solvent.

Hereinafter, the respective components will be described in detail.

### Particles

As the particles, any particles can be used, however, the composition is preferably constituted by porous particles. According to this, when the three-dimensionally shaped article is produced, the binding agent in the binding liquid can be made to favorably penetrate into the pores, and as a result, the composition can be favorably used for producing the three-dimensionally shaped article having excellent mechanical strength.

Examples of a constituent material of the particles include an inorganic material, an organic material, and a composite of these materials.

Examples of the inorganic material constituting the particles include various metals and metal compounds.

Examples of the metal compounds include various metal oxides such as silica, alumina, titanium oxide, zinc oxide, zirconium oxide, tin oxide, magnesium oxide, and potassium titanate; various metal hydroxides such as magnesium hydroxide, aluminum hydroxide, and calcium hydroxide; various metal nitrides such as silicon nitride, titanium nitride, and aluminum nitride; various metal carbides such as silicon carbide and titanium carbide; various metal sulfides such as zinc sulfide; various metal carbonates such as calcium carbonate and magnesium carbonate; various metal sulfates such as calcium sulfate and magnesium sulfate; various metal silicates such as calcium silicate and magnesium silicate; various metal phosphates such as calcium phosphate; various metal borates such as aluminum borate and magnesium borate; and composites of these materials.

Examples of the organic material constituting the particles include synthetic resins and natural polymers, and more specific examples thereof include a polyethylene resin; polypropylene; polyethylene oxide; polypropylene oxide; polyethylenimine; polystyrene; polyurethane; polyurea; polyester; a silicone resin; an acrylic silicone resin; a polymer containing a (meth)acrylate ester as a constituent monomer such as poly(methyl methacrylate); a crosspolymer (an ethylene acrylic acid copolymer resin or the like) containing a (meth)acrylate ester as a constituent monomer such as a methyl methacrylate crosspolymer; polyamide resins such as nylon 12, nylon 6, and copolymer nylon; polyimide; carboxymethyl cellulose; gelatin; starch; chitin; and chitosan.

Above all, the particles are preferably particles constituted by an inorganic material, more preferably particles constituted by a metal oxide, further more preferably particles constituted by silica. According to this, the properties such as mechanical strength and light resistance of the three-dimensionally shaped article can be made particularly excellent.

The average particle diameter of the particles is not particularly limited, but is preferably 1 μm or more and 25 μm or less, more preferably 1 μm or more and 15 μm or less. According to this, the mechanical strength of the three-dimensionally shaped article can be made particularly excellent, and also the occurrence of undesirable irregularities or the like in the three-dimensionally shaped article to be produced is more effectively prevented, and the dimensional accuracy of the three-dimensionally shaped article can be made particularly excellent. Further, the fluidity of a three-dimensional shaping powder and the fluidity of the three-dimensional shaping composition containing a three-dimensional shaping powder can be made particularly excellent, and thus, the productivity of the three-dimensionally shaped article can be made particularly excellent. The “average particle diameter” as used herein refers to an average particle diameter on a volume basis and can be determined by, for example, adding a sample to methanol, followed by dispersion for 3 minutes using an ultrasonic disperser, and then, measuring the resulting dispersion liquid using a particle size distribution analyzer employing a Coulter counter method (for example, model TA-II, manufactured by Coulter Electronics, Inc.) with an aperture of 50 μm.

The Dmax of the particles is preferably 3 μm or more and 40 μm or less, more preferably 5 μm or more and 30 μm or less. According to this, the mechanical strength of the three-dimensionally shaped article can be made particularly excellent, and also the occurrence of undesirable irregularities or the like in the three-dimensionally shaped article to be produced is more effectively prevented, and the dimensional accuracy of the three-dimensionally shaped article can be made particularly excellent. Further, the fluidity of a three-dimensional shaping powder and the fluidity of the three-dimensional shaping composition containing a three-dimensional shaping powder can be made particularly excellent, and thus, the productivity of the three-dimensionally shaped article can be made particularly excellent.

The content of the three-dimensional shaping powder in the three-dimensional shaping composition is preferably 10% by mass or more and 90% by mass or less, more preferably 15% by mass or more and 58% by mass or less. The particles may be porous, and a bulk density ranging from about 0.1 g/cm³ to 1.0 g/cm³ is appropriate, and a porous powder having a bulk density ranging from 0.15 g/cm³ to 0.5 g/cm³ is more preferred. According to this, while making the fluidity of the three-dimensional shaping composition sufficiently excellent, the mechanical strength of the finally obtained three-dimensionally shaped article can be made particularly excellent.

### Solvent

The three-dimensional shaping composition may contain a solvent. By including the solvent therein, the fluidity of the three-dimensional shaping composition can be made particularly excellent, and thus, the productivity of the three-dimensionally shaped article can be made particularly excellent.

The solvent constituting the three-dimensional shaping composition is not particularly limited, however, it is preferred to use an aqueous solvent. The aqueous solvent is a solvent composed of water and/or a liquid having excellent compatibility with water, but is preferably a solvent composed mainly of water, and particularly preferably a solvent containing water in an amount of 70 wt % or more, more preferably a solvent containing water in an amount of 90 wt % or more. According to this, a water-soluble resin can be more reliably dissolved, and the fluidity of the three-dimensional shaping composition and the uniformity of the composition of the layer 1 to be formed using the three-dimensional shaping composition can be made particularly excellent. Further, water is easily removed after the layer 1 is formed, and also water is less likely to have an adverse effect even if it remains in the three-dimensionally shaped article. Further, water is advantageous also from the viewpoint of safety for the human body, environmental issues, and the like.

The content of the solvent in the three-dimensional shaping composition is preferably 5% by mass or more and 75% by mass or less, more preferably 35% by mass or more and 70% by mass or less. According to this, the effect of including the solvent as described above is more remarkably exhibited, and also the solvent can be easily removed in a short time in the production process for the three-dimensionally shaped article, and thus, it is advantageous from the viewpoint of improvement of the productivity of the three-dimensionally shaped article.

In particular, in the case where the three-dimensional shaping composition contains water as the solvent, the content of water in the three-dimensional shaping composition is preferably 20% by mass or more and 73% by mass or less, more preferably 50% by mass or more and 70% by mass or less. According to this, the effect as described above is more remarkably exhibited.

### Water-Soluble Resin

The three-dimensional shaping composition may contain a water-soluble resin along with a plurality of particles. By including a water-soluble resin therein, the particles can be bound (temporarily fixed) to one another, and thus, undesirable scattering or the like of the particles can be effectively prevented. As a result, the safety for workers and the dimensional accuracy of the three-dimensionally shaped article to be produced can be improved. Further, the water-soluble resin has high affinity for the surfaces of the particles, and therefore can easily cover the surfaces of the particles.

The water-soluble resin is preferably a resin which can be at least partially dissolved in water, but is more preferably, for example, a resin having a solubility in water (the mass of the resin that can be dissolved in 100 g of water) at 25° C. of 5 g/100 g of water or more, further more preferably a resin having a solubility in water at 25° C. of 10 g/100 g of water or more. According to this, the affinity for the surfaces of the particles can be more enhanced, and the unbound particles can be more easily removed in the unbound particle removal step.

In the three-dimensional shaping composition, the water-soluble resin is preferably in the form of a liquid (for example, in a dissolved state, in a melted state, or the like) at least in the layer forming step. According to this, the uniformity of the thickness of the layer 1 to be formed using the three-dimensional shaping composition can be further enhanced easily and reliably.

As the water-soluble resin, a resin containing at least one compound selected from the group consisting of polyvinyl alcohol, polyvinylpyrrolidone, sodium polyacrylate, ammonium polyacrylate, carboxymethyl cellulose, hydroxyethyl cellulose, polyethylene oxide, polyethylene glycol, polyacrylamide, and polyethylenimine is preferably used. According to this, the affinity between the water-soluble resin and the particles (a hydrogen bond between a water-soluble functional group of the water-soluble resin and a hydroxy group, a carboxyl group, or an amino group on the surface of the particle) can be particularly enhanced.

### Another Component

The three-dimensional shaping composition may contain a component other than the above-mentioned components. Examples of such a component include a polymerization initiator, a polymerization accelerator, a permeation accelerator, a wetting agent (humectant), a fixing agent, an antifungal agent, a preservative, an antioxidant, a UV absorber, a chelating agent, and a pH adjusting agent.

### 4. Binding Liquid

Next, a binding liquid will be described in detail.

### Binding Agent

The binding liquid contains at least a binding agent.

The binding agent is a component having a function to bind the particles by being cured.

Examples of the binding agent include a thermoplastic resin; a thermosetting resin; various photocurable resins such as a visible light curable resin which is cured by a light in the visible light range (a photocurable resin in a narrow sense), a UV curable resin, and an IR curable resin; and an X-ray curable resin, and one resin or a combination of two or more resins selected from these can be used. Above all, the binding agent is preferably a curable resin from the viewpoint of the mechanical strength of the three-dimensionally shaped article to be obtained, the productivity of the three-dimensionally shaped article, and the like. Further, among the various curable resins, particularly, a UV curable resin (polymerizable compound) is preferred from the viewpoint of the mechanical strength of the three-dimensionally shaped article to be obtained, the productivity of the three-dimensionally shaped article, the storage stability of the binding liquid, and the like.

As the UV curable resin, a compound whose addition polymerization or ring-opening polymerization is initiated by a radical species, a cationic species, or the like generated from a photopolymerization initiator by UV irradiation, thereby forming a polymer is preferably used. Examples of the polymerization form of the addition polymerization include radical, cationic, anionic, metathesis, and coordination polymerization. Further, examples of the polymerization form of the ring-opening polymerization include cationic, anionic, radical, metathesis, and coordination polymerization.

The content of the binding agent in the binding liquid is preferably 80% by mass or more, more preferably 85% by mass or more. According to this, the mechanical strength of the finally obtained three-dimensionally shaped article can be made particularly excellent.

### Another Component

The binding liquid may contain a component other than the above-mentioned components. Examples of such a component include various coloring agents such as a pigment and a dye, a dispersant, a surfactant, a polymerization initiator, a polymerization accelerator, a solvent, a permeation accelerator, a wetting agent (humectant), a fixing agent, an antifungal agent, a preservative, an antioxidant, a UV absorber, a chelating agent, a pH adjusting agent, a thickening agent, a filler, an anti-aggregation agent, and a defoaming agent.

In particular, by including a coloring agent in the binding liquid, the three-dimensionally shaped article colored in a color corresponding to the color of the coloring agent can be obtained.

In particular, by including a pigment as the coloring agent, the light resistance of the binding liquid and the three-dimensionally shaped article can be made favorable. As the pigment, either of an inorganic pigment and an organic pigment can be used.

In the case where the binding liquid contains a pigment, the average particle diameter of the pigment is preferably 300 nm or less, more preferably 50 nm or more and 250 nm or less. According to this, the ejection stability of the binding liquid and the dispersion stability of the pigment in the binding liquid can be made particularly excellent, and also an image with higher image quality can be formed.

In the case where the binding liquid contains a coloring agent, the content of the coloring agent in the binding liquid is preferably 1% by mass or more and 20% by mass or less. According to this, particularly excellent concealing property and color reproducibility are obtained.

In particular, in the case where the binding liquid contains titanium oxide as the coloring agent, the content of titanium oxide in the binding liquid is preferably 12% by mass or more and 18% by mass or less, more preferably 14% by mass or more and 16% by mass or less. According to this, a particularly excellent concealing property is obtained.

The viscosity of the binding liquid is preferably 10 mPa·s or more and 25 mPa·s or less, more preferably 15 mPa·s or more and 20 mPa·s or less. According to this, the ejection stability of the binding liquid by an inkjet method can be made particularly excellent. Incidentally, the “viscosity” as used herein refers to a value measured at 25° C. using an E-type viscometer (VISCONIC ELD, manufactured by Tokyo Keiki, Inc.).

In the production of the three-dimensionally shaped article, multiple types of binding liquids may be used.

For example, a binding liquid which contains a coloring agent (a color ink) and a binding liquid which does not contain a coloring agent (a clear ink) may be used. According to this, for example, as a binding liquid to be applied to a region which has an effect on the color tone in appearance of the three-dimensionally shaped article, a binding liquid which contains a coloring agent is used, and as a binding liquid to be applied to a region which does not have an effect on the color tone in appearance of the three-dimensionally shaped article, a binding liquid which does not contain a coloring agent may be used. Further, in the finally obtained three-dimensionally shaped article, multiple types of binding liquids may be used in combination such that a region (a coating layer) is provided using a binding liquid which does not contain a coloring agent on the outer surface of a region formed using a binding liquid which contains a coloring agent.

In addition, for example, multiple types of binding liquids which contain a coloring agent having a different composition may be used. According to this, by using these binding liquids in combination, an expressible color reproduction range can be widened.

In the case where multiple types of binding liquids are used, it is preferred to use at least a cyan binding liquid, a magenta binding liquid, and a yellow binding liquid. According to this, by using these binding liquids in combination, an expressible color reproduction range can be further widened.

Further, by using a white binding liquid in combination with the other colored binding liquids, for example, the following effects are obtained. That is, the finally obtained three-dimensionally shaped article can be configured to have a first region, to which a white binding liquid is applied, and a region, which overlaps with the first region and is provided on the outer surface side of the first region, and to which a colored binding liquid whose color is other than white is applied. According to this, the first region to which the white binding liquid is applied can exhibit a concealing property, and the chroma of the three-dimensionally shaped article can be further enhanced.

### 5. Three-Dimensionally Shaped Article

The three-dimensionally shaped article according to the invention is produced using a three-dimensionally shaped article production apparatus as described above. According to this, a three-dimensionally shaped article with high reliability can be provided.

The use of the three-dimensionally shaped article according to the invention is not particularly limited, however, examples of the use include ornaments and exhibits such as dolls and figures; and medical devices such as implants.

Further, the three-dimensionally shaped article according to the invention may be applied to any of prototypes, mass-produced products, and custom-made products.

Hereinabove, preferred embodiments of the invention have been described, however, the invention is not limited thereto.

For example, in the above embodiments, a configuration in which the recovery section and the shaping section are separate bodies has been described, however, the configuration is not limited thereto, and the recovery section and the shaping section may be integrally formed.

Further, in the three-dimensionally shaped article production method, a pre-treatment step or a post-treatment step may be performed as needed.

Examples of the pre-treatment step include a step of cleaning the shaping stage.

Examples of the post-treatment step include a washing step, a shape adjustment step in which deburring or the like is performed, a coloring step, a coating layer forming step, and a UV curable resin curing completion step in which a light irradiation treatment or a heating treatment for reliably curing the uncured UV curable resin is performed.

Further, in the above-mentioned embodiments, a case where the binding liquid is applied to all the layers has been described, however, a layer to which the binding liquid is not applied may be included. For example, the binding liquid is not applied to a layer formed immediately above the shaping stage, and the layer may be made to function as a sacrifice layer.

Further, in the above-mentioned embodiments, a case where the ejection step is performed by an inkjet method has been mainly described, however, the ejection step may be performed using another method (for example, another printing method).

The entire disclosure of Japanese patent No. 2015-042105, filed Mar. 4, 2015 is expressly incorporated by reference herein.

What is claimed is:

1. A three-dimensionally shaped article production apparatus, which is an apparatus for producing a three-dimensionally shaped article by stacking a layer, comprising:
a shaping section in which the three-dimensionally shaped article is formed;
a layer forming unit which forms the layer using a three-dimensional shaping composition containing particles; and
an ejection unit which ejects a binding liquid for binding the particles onto the layer, wherein
the shaping section includes a mask which has an opening with a size corresponding to the size of the three-dimensionally shaped article, and
the layer is formed in the opening.

2. The three-dimensionally shaped article production apparatus according to claim 1, wherein the mask is detachable.

3. The three-dimensionally shaped article production apparatus according to claim 1, wherein the three-dimensional shaping composition contains a solvent.

4. The three-dimensionally shaped article production apparatus according to claim 1, wherein
the shaping section includes a support to which the mask is fixed, and
a lift stand which goes up and down with respect to the support.

5. The three-dimensionally shaped article production apparatus according to claim 1, wherein
the apparatus includes a shaping stage, which is placed on the upper surface of the lift stand, and on which the layer is stacked,
and the shaping stage has a size corresponding to the size of the opening.

6. The three-dimensionally shaped article production apparatus according to claim 5, wherein the shaping stage is constituted by a porous body.

7. A three-dimensionally shaped article, which is produced by the three-dimensionally shaped article production apparatus according to claim 1.

8. A three-dimensionally shaped article, which is produced by the three-dimensionally shaped article production apparatus according to claim 2.

9. A three-dimensionally shaped article, which is produced by the three-dimensionally shaped article production apparatus according to claim 3.

10. A three-dimensionally shaped article, which is produced by the three-dimensionally shaped article production apparatus according to claim 4.

11. A three-dimensionally shaped article, which is produced by the three-dimensionally shaped article production apparatus according to claim 5.

12. A three-dimensionally shaped article, which is produced by the three-dimensionally shaped article production apparatus according to claim 6.
